(19) United States
(12) Patent Application Publication
(10) Pub. No.: US 2005/0286089 A1
(43) Pub. Date: Dec. 29, 2005

(54) Method and apparatus for directly printing synthesized image combined with background template

(75) Inventors: Kwang-chul Lee, Suwon-si (KR); Eun-hee Rhim, Suwon-si (KR); Seok Ryu, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/165,066

(22) Filed: Jun. 24, 2005

(30) Foreign Application Priority Data
Jun. 24, 2004 (KR) 10-2004-0047625

(51) Int. Cl. H04N 1/387

(52) U.S. Cl. 358/450

(57) ABSTRACT

Provided are a method and an apparatus for directly printing a synthesized image combined with a background template. The method includes selecting a background template image to be combined with a photographic image, combining the selected background template image with the photographic image and composing a synthesized image, and transferring the photographic image and combination information of the background template image and the photographic image to a printer.

### CROSS-REFERENCE TO RELATED APPLICATION

This application claims priority from Korean Patent Application No. 10-2004-0047625 filed on Jun. 24, 2004 in the Korean Intellectual Property Office, the disclosure of which is incorporated herein by reference in its entirety.

### BACKGROUND OF THE INVENTION

1. Field of the Invention

The present invention relates to direct image printing using a printer, and more particularly, to a method and apparatus for directly printing a synthesized image combined with a background template.

2. Description of the Related Art

Advances in digital technology have led to a reduction in the price of a digital camera while providing for a wide variety of functions. Digital cameras have undergone a remarkable market expansion and purchasers have become able to take individual and characteristic photographs using the digital cameras. The attractiveness of the digital cameras to purchasers is due in large part to capabilities of editing captured images using a computer, printing the captured images through the printer and storing their memorable images in the form of photographs. Mobile phones with built-in digital cameras are becoming increasingly prevalent. These types of devices are referred to as “camera phones.” This combination of phone and camera features has provided large appeal to consumers by allowing for them to have greater mobility without missing opportunities for expressing their own individuality through various photographic moments captured by the camera phone.

FIG. 1 illustrates a conventional method for printing a photographic image stored in a camera phone 110.

The camera phone 110 basically serves as a mobile phone and a user can take photographs using a camera module 112. The user can edit photographs captured by the camera phone 110 using an image work program of a computer 130 or print the photographs through a printer 120 connected to the computer 130. In such a conventional method for printing a photographic image, however, it is necessary to turn on a computer to print out a photographic image captured by the camera phone 110 using a printer connected to the computer, which is quite an inconvenient, time-consuming procedure. Actually, turning on the computer that provides various functions other than photo printouts requires quite a long time to boot. As such, several attempts have been made for directly printing an image stored in a camera phone. Recently, a printer incorporating a microprocessor has been proposed. According to the proposed printer, an image stored in a camera phone is directly printed using the microprocessor without using a computer, as shown in FIG. 2.

FIG. 2 illustrates another conventional method for printing a photographic image stored in a camera phone.

A user directly prints a photograph captured by a camera module 212 of a camera phone 210 to a printer 220. The printer 220 directly prints the photograph captured by the camera phone 210, the photograph received from the camera phone 210. When an image file of the photograph captured by the camera phone 210 is a compressed file such as JPEG, the microprocessor of the printer 220 converts the file into a file format that can be printed and prints it. A printed image may be a photo or image received from an external network or apparatus as well as the photograph captured by the camera phone 210, which will be described with reference to FIG. 3.

FIG. 3 illustrates a conventional method for receiving an image from an external network or apparatus using a camera phone.

A camera phone 310 can download an image or a photo from an Internet server 360 via a mobile communication network. The mobile communication network includes a base station 320 connected to the camera phone 310 via a wireless medium, a mobile communication switching station 330, a home location register (HLR) 332, and a visitor location register (VLR) 334.

The base station 320 communicates with the camera phone 310 in a wireless manner. The mobile communication switching station 330 connects a call path requested by the camera phone 310. The HLR 332 and the VLR 334 keep subscriber information records placed in a mobile communication service subscriber resident region. A WAP gateway 340 connects the mobile communication network to a wired Internet network 350.

As described above, although a photograph can be directly printed to a printer using a digital photographing apparatus such as a camera phone, the user may wish to print the photograph combined with a background screen. In this case, the user should use the computer. The user may also want to print the photograph combined with a background effect such as a raining, snowing or twinkling effect, in which case a computer is required.

Accordingly, it would be advantageous to provide a method and apparatus for directly printing a synthesized image combined with a background screen or background effect to a printer in a digital photographing apparatus.

### SUMMARY OF THE INVENTION

The present invention provides a method and apparatus for directly printing a synthesized image combined with a background template from a digital photographing apparatus to a printer.

The above stated object as well as other objects, features and advantages of the present invention will become clear to those skilled in the art upon review of the following description.

According to an aspect of the present invention, there is provided a method for directly printing a synthesized image, the method including: selecting a background template image to be combined with a photographic image; combining the selected background template image with the photographic image and composing a synthesized image; and transferring the photographic image and combination information of the background template image and the photographic image to a printer.

According to another aspect of the present invention, there is provided a method for directly printing a synthesized image, the method including receiving a photographic image and combination information of a first background template image and the photographic image from a digital photographing apparatus, combining the first background template image and the received image with each other according to the received combination information and composing a synthesized image, and printing the synthesized image.

According to still another aspect of the present invention, there is provided a digital photographing apparatus including a photographing unit converting incident light into an image signal, a memory in which a photographic image captured by the photographing unit and a background template image are stored, a user interface to which a user's instruction is input, a display unit which displays the photographic image and the background template image to a user, a microprocessor combining the photographic image and the background template with each other according to the user's instruction input through an instruction inputting unit and composing a synthesized image, and a communication unit transferring the photographic image and combination information of the background template image and the photographic image to a printer.

According to yet another aspect of the present invention, there is provided a printer including a communication unit receiving an image and combination information of a background template image and the image from a digital photographing apparatus, a memory in which a background template image is stored, a microprocessor combining the background template image stored in the memory and the received image with each other according to the received combination information and composing a synthesized image, and a printing unit printing the synthesized image.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional method for printing a photographic image stored in a camera phone;

FIG. 2 illustrates a conventional method for printing a photographic image stored in a camera phone;

FIG. 3 illustrates a conventional method for receiving an image from an external network or apparatus using a camera phone;

FIG. 4 is a block diagram of a structure of an apparatus for printing a synthesized image according to an exemplary embodiment of the present invention;

FIG. 5 is a flowchart illustrating a method for directly printing a synthesized image according to an exemplary embodiment of the present invention;

FIG. 6 is a flowchart illustrating a template uploading process according to an exemplary embodiment of the present invention;

FIG. 7 is a flowchart illustrating a process of printing a synthesized image according to an exemplary embodiment of the present invention;

FIG. 8 is a flowchart illustrating a process of composing a synthesized image according to an exemplary embodiment of the present invention;

FIG. 9 is a flowchart illustrating a direct image printing process according to an exemplary embodiment of the present invention;

FIG. 10 illustrates a process of manually selecting an image region according to an exemplary embodiment of the present invention;

FIG. 11 illustrates a process of manually selecting an image region according to an exemplary embodiment of the present invention;

FIG. 12 illustrates a synthesized image composed according to an exemplary embodiment of the present invention; and

FIG. 13 illustrates a synthesized image composed according to an exemplary embodiment of the present invention.

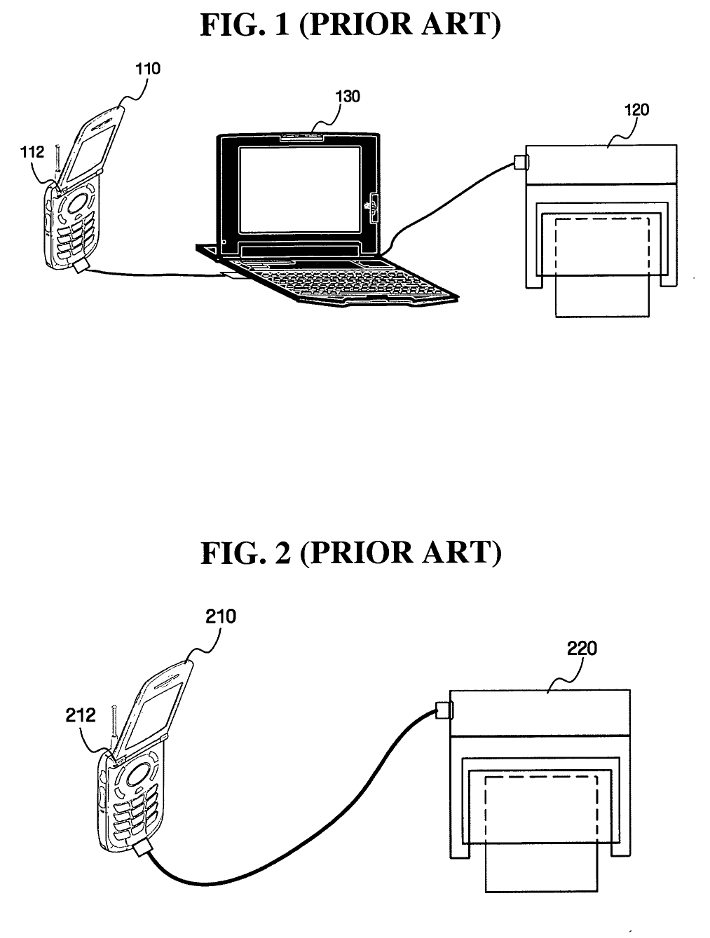

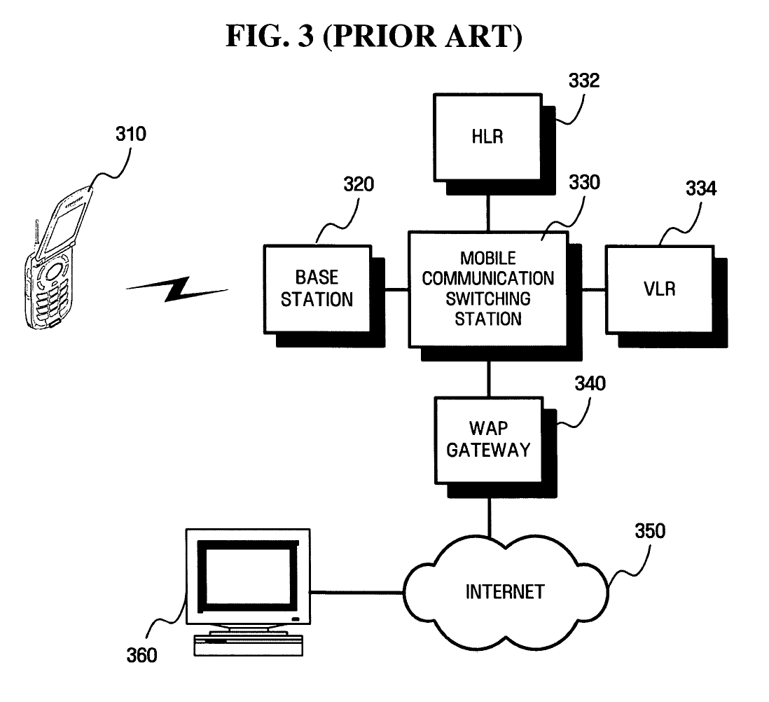

### DETAILED DESCRIPTION OF EXEMPLARY EMBODIMENTS OF THE INVENTION

The present invention will now be described more fully with reference to the accompanying drawings, in which exemplary embodiments of the invention are shown.

In the following exemplary embodiments, the structure of a digital photographing apparatus and a printer, which are used in directly printing a synthesized image combined with a background template, and an operation between the digital photographing apparatus and the printer, will be described. The digital photographing apparatus includes a photographic unit which converts incident light into an image signal. Examples of the digital photographing apparatus include, but are not limited to, a camera phone, a digital camera or a digital camcorder, and the like. Current widely used photographic units include a lens that receives light reflected from a subject, a sensor that converts light from the lens into an image signal, an analog/digital converter that converts the image signal obtained from the sensor into a digital signal, a signal processor that obtains image data having a predetermined image format such as BMP or JPEG from the digital signal, and the like. Known photographic units employ a complementary metal oxide semiconductor (CMOS) or a charge-coupled device (CCD) imaging system depending on charge transfer mechanism. Hereinafter, the digital photographing apparatus will be described based on a camera phone.

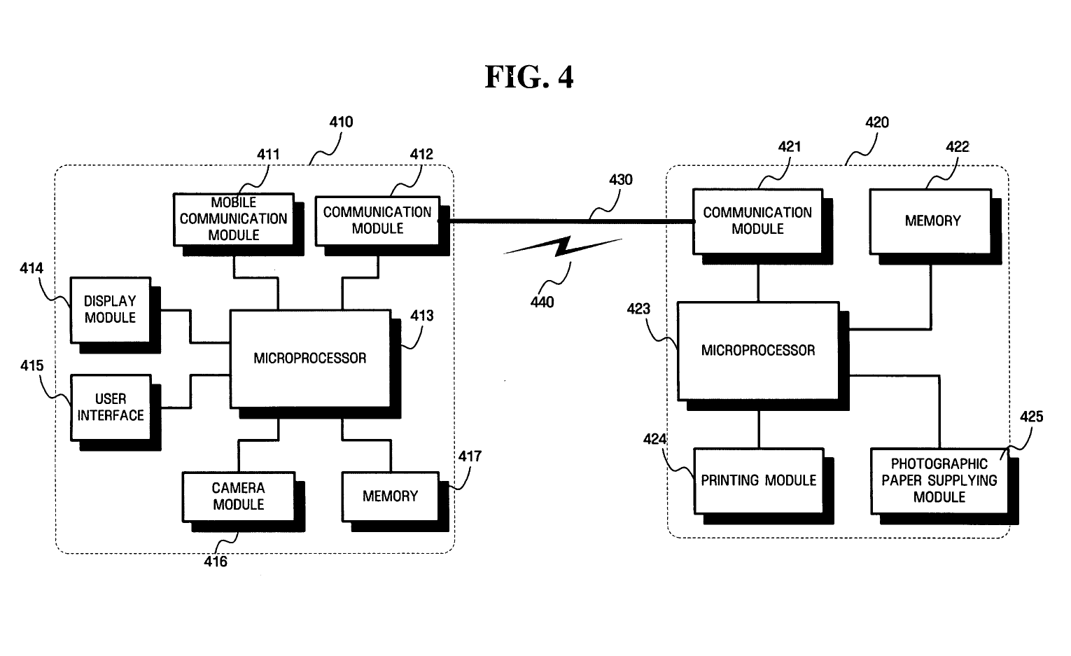

FIG. 4 is a block diagram of a structure of an apparatus for printing a synthesized image according to an exemplary embodiment of the present invention.

Referring to FIG. 4, a camera phone 410 has both digital camera and mobile phone functions. To perform these functions, the camera phone 410 includes a mobile communication module 411 and a camera module 416. The mobile communication module 411 allows a user to make a voice call or data communications using a CDMA (Code Division Multiple Access), GSM (Global System for Mobile Communications) or WCDMA (Wideband CDMA) mode.

The camera module 416 obtains an image from light from a subject. The camera module 416 may be implemented using a CCD or CMOS method but is not limited thereto. The image of the subject taken by the camera module 416 is stored in a memory 417.

The memory 417 may be an electrically, magnetically or optically writable and erasable nonvolatile memory. In an exemplary embodiment of the present invention, the memory 417 includes a flash memory. The flash memory includes a NOR flash memory type and a NAND flash memory type. In an exemplary embodiment of the present invention, an image is stored using the NAND flash memory type, which is suitable for storing a large capacity of image data. The flash memory is just an example, and useful examples of the nonvolatile memory are not limited thereto. The memory 417 also stores a background template to be combined with the image of the subject taken by the camera module 416.

The background template is a concept embracing a background image or background effect to be combined with the image. For example, a person may want a photograph synthesized such that he or she looks like they are in the garden, although they are not actually not in the garden. Then, the photograph is combined with a garden background image. In another case, when a person wants a photograph with a seaside background, a seaside background image is combined with a photograph of the person. Likewise, when a person wants a photograph with a rainy day effect, a photograph of the person is combined with a rainy background effect.

The user selects one from among a plurality of background templates displayed on a display module 414 via a user interface 415. The selected background template is combined with the image of the subject. The user interface 415 to which a user's instruction is input may be a keypad, a touch pen, a ball track, or a touch screen, but is not limited thereto. An image display apparatus may be an LCD, an organic electroluminescence (EL), a field emission display (FED), a CRT, or PDP, but not limited thereto. In a case where the user interface 415 is a touch screen, the display module 414 may partly function as the user interface 415.

The microprocessor 413 receives the user's instruction from the user interface 415 according to a program stored in the memory 417 or a program storage ROM (not shown), and controls the camera module 416, the display module 414, the communication module 412, the memory 417, and the mobile communication module 411. In addition, the microprocessor 413 composes a synthesized image by combining a background template image selected using the user interface 415 with a photographic image.

The synthesized image is transferred to the printer 420 through the communication module 412. The synthesized image transferred to the printer 420 having the background template image may be a synthesized image itself. However, a photographic image and combination information of the photographic image and a background template image are preferably transferred to the printer 420. Hereinafter, a synthesized image or synthesized image data transferred to the printer 420 means a photographic image and combination information of the photographic image and the background template image, but is not limited thereto. The combination information of the photographic image and the background template image may include an identifier for a background template, region information for a photographic image, and combination location information of a background template image and a photographic image, and so on.

The communication module 412 may be a wired interface such as USB, IEEE1394, UART or Ethernet cable, or a wireless interface such as IrDA, Bluetooth, IEEE 802.11x or IEEE 802.15.3. In a case where the communication module 412 is a wired interface, the wired interface transfers synthesized image data to the printer 420 via a wired medium 430 such as a USB cable or an IEEE1394 cable. In a case where the communication module 412 is a wireless interface, the wireless interface transfers the data to the printer 420 via a wireless medium 440.

The printer 420 selects the background template image stored in the printer 420 as received combination information. The received photographic image is combined with the selected background template image, thereby composing a synthesized image. Then, the printer 420 converts the synthesized image into output image data, followed by printing the same. For example, when the synthesized image is an image having a JPEG format and the printed output data is an image having a BMP format, the JPEG image is converted into the BMP format and printed.

In an exemplary embodiment of the present invention, when a plurality of background template images are stored in the memory 417 of the camera phone 410, a background template list includes information in which background template images are simplified in the memory 417, so that the user can easily search background templates to select desired background templates. The background template list includes the simplified information. For example, the background template list includes an identifier for the background template images and may further include a text for briefly explaining the background template images or thumnail images for the background template images or both of them. When the background template list includes thumnail images, the user can more easily select desired background templates than in the case where the background template list includes only the explanatory text.

Now, composing a synthesized image using a background template list will be described in more detail. The user selects a desired background template image from a background template list displayed through the display module 414. The selected background template image is combined with a photographic image using an operation performed by the microprocessor 413.

The printer 420 includes a communication module 421 which communicates with the camera phone 410 via the wired medium 430 or the wireless medium 440, a memory 422 in which at least one background template image is stored, a microprocessor 423, a printing module 424 which prints a photographic image from the camera phone 410 or a synthesized image, and a photographic paper supplying module 425 which supplies photographic paper to be printed through the printing module 424 and printed as a photo.

The communication module 421 may be a wired interface such as USB, IEEE1394, UART or Ethernet cable, or a wireless interface such as IrDA, Bluetooth, IEEE 802.11x or IEEE 802.15.3. In a case where the communication module 421 is a wired interface, data transferred from the camera phone 410 is received through the wired medium 430 such as a USB cable or an IEEE1394 cable. In a case where the communication module 421 is a wireless interface, data transferred from the camera phone 410 is received through the wireless medium 440.

The microprocessor 423 creates output image data for printing the synthesized image through the printing module 424 using synthesized image data received by the communication module 421. If the data received by the communication module 421 is a synthesized image self, the microprocessor 423 converts the synthesized image into output image data to be supplied to the printing module 424. If the data received by the communication module 421 is combination information with the photographic image, specifically combination information of background template image and photographic image, the microprocessor 423 selects the background template image stored in the memory 422 using the combination information and combines the received photographic image with the background template image, thereby composing a synthesized image. The microprocessor 423 converts the synthesized image into output image data to be supplied to the printing module 424.

The output image data is supplied to the printing module 424, and the printing module 424 prints the synthesized image on photographic paper. The printing module 424 may print the synthesized image using an ink cartridge or using a laser printing module but is not limited thereto.

The term ‘module’, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more computers in a communication system.

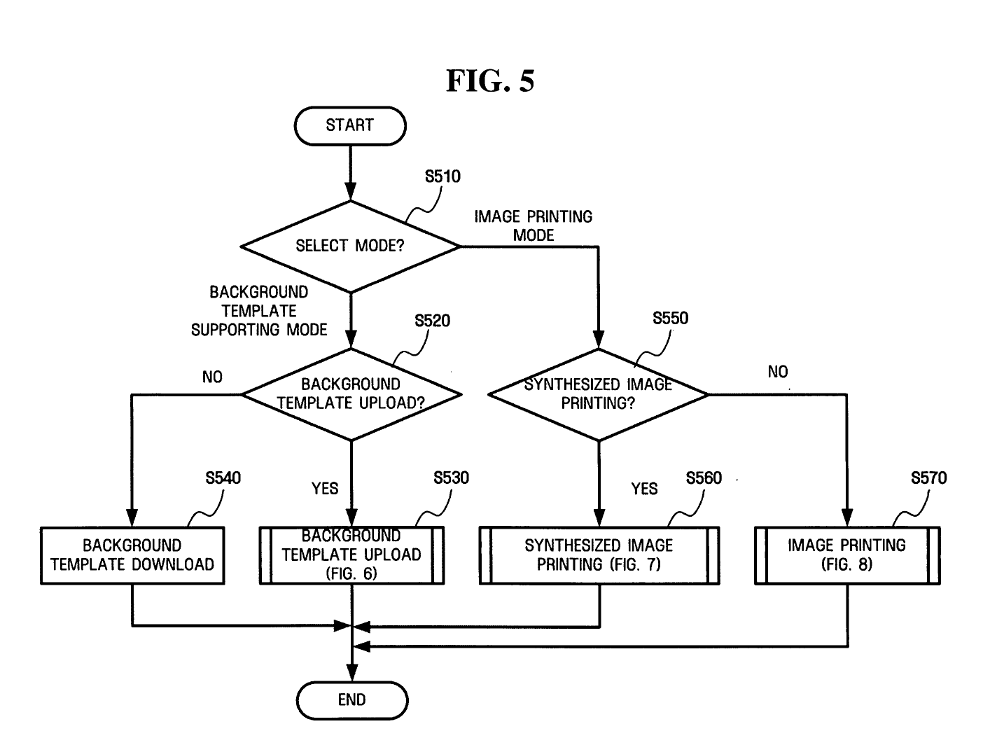

According to an exemplary embodiment of the present invention, the user can directly print the synthesized image through the printer by use of a digital photographing apparatus without using a computer. A greater detailed operation thereof will be described with reference to FIG. 5.

FIG. 5 is a flowchart illustrating a method for directly printing a synthesized image according to an exemplary embodiment of the present invention.

In operation S510, the user first selects a mode of the digital photographing apparatus. The mode includes an image printing mode and a background template supporting mode.

In operation S520, the user selects whether background template uploading or background template downloading is performed in the background template supporting mode. The background template upload includes the digital photographing apparatus receiving a background template image or a background template list from an external network or apparatus and storing the received background template image or background template list. The background template downloading includes storing the background template image or background template list that has been stored in the digital photographing apparatus in an external apparatus.

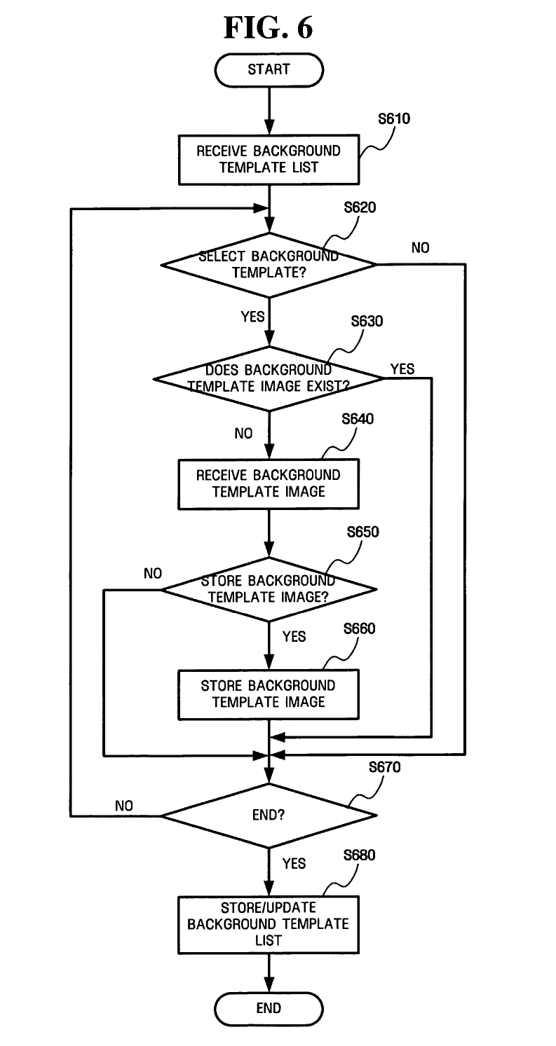

If the background template uploading is selected, the background template uploading is performed in operation S530. A greater detailed operation thereof will later be described with reference to FIG. 6.

If the background template downloading is selected, the background template downloading is performed in operation S540. In order to obtain more memory space for the digital photographing apparatus, the user may have to delete the background template image. In this case, a background template is first downloaded into another apparatus having a memory space through background template downloading and the background template image is then deleted. In some cases, the user may have to share the background template image of the digital photographing apparatus with other devices. In such cases, background template downloading is also performed. When the synthesized image is transferred to the printer, for example, the printer should be in a state in which the background template image has been previously stored in the printer prior to composition of the synthesized image. To this end, the background template image that has previously been stored in the digital photographing apparatus is stored in the printer using the background template downloading in operation S540.

If the image printing mode is selected, an image printing process is performed. In operation S550, the user selects synthesized image printing and image printing when performing the image printing process.

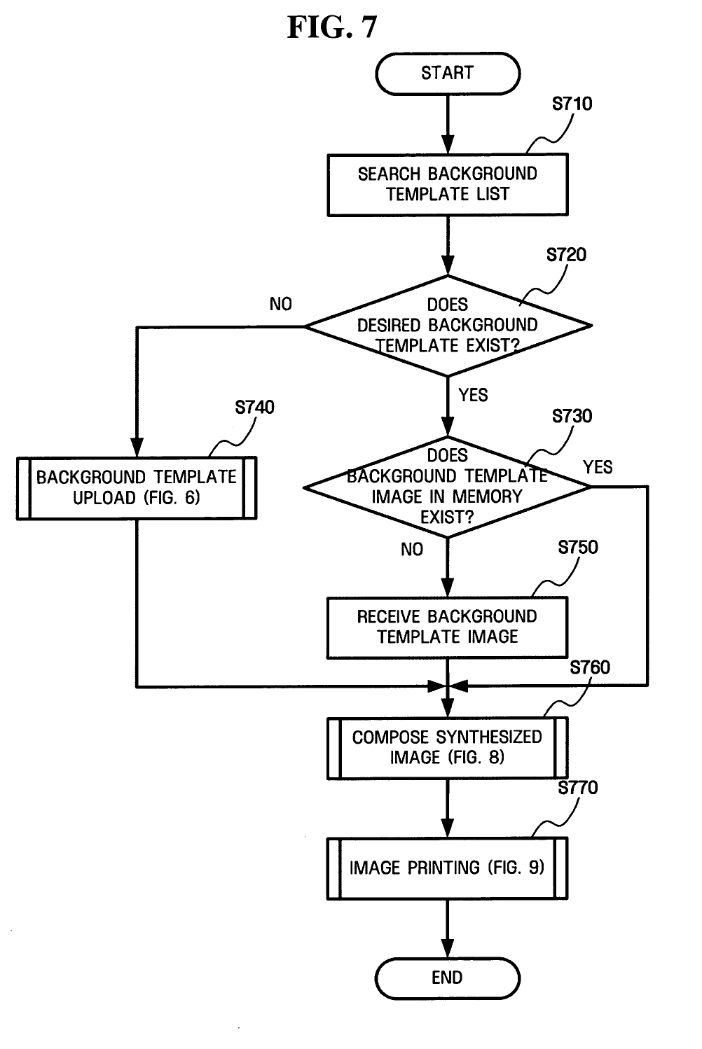

If it is determined that synthesized image printing is selected, a synthesized image printing process (S560) is performed. A more detailed operation thereof will be described with reference to FIG. 7.

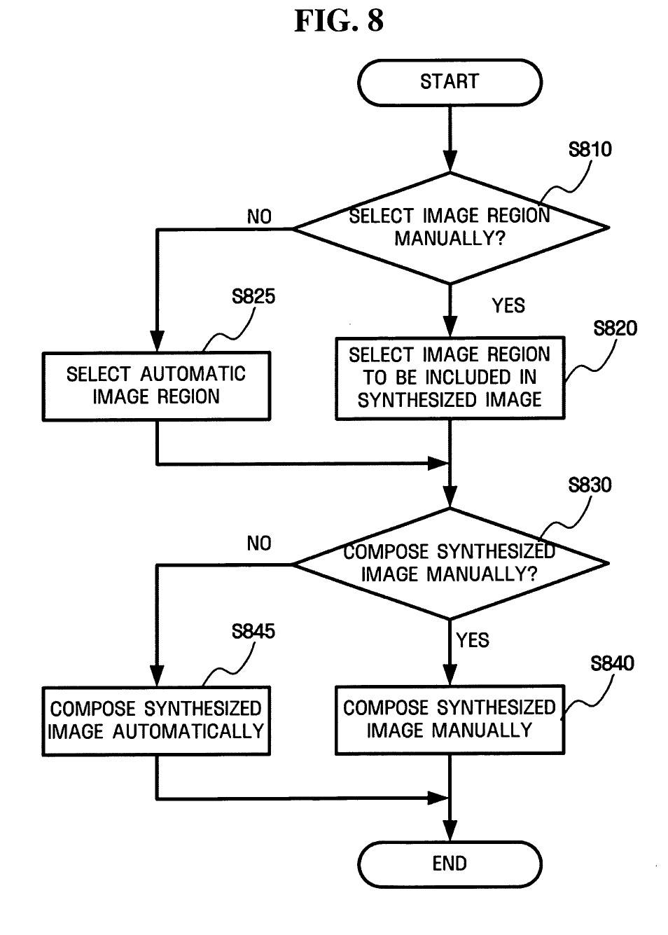

If it is determined that image printing is selected, an image printing process (S570) is performed. A more detailed operation thereof will be described with reference to FIG. 8.

FIG. 6 is a flowchart illustrating a template uploading process according to an exemplary embodiment of the present invention.

In operation S610, a background template list is requested from an external network or apparatus and received. The background template list includes an identifier for background template images and may further include a text for briefly explaining the background template images or thumbnail images for the background template images or both of them. When the background template list includes thumnail images, the user can more easily select desired background templates than in the case where the background template list includes only the explanation text.

In operation S620, the user selects a background template from the received background template list. When the background template list includes thumbnail images, the user can select a desired background template while seeing the thumbnail images.

If the background template is selected, it is determined whether an image for the selected background template exists in a memory in operation S630. If the image for the selected background template is not stored in the memory, the background template image is received from the external network or apparatus in operation S640. If the image for the selected background template is stored in the memory, a process of receiving the background template image is not performed.

After the background template is received, the user determines whether to store the background template image in operation S650. If the user determines to store the background template image, the background template image is stored in operation S660. If the user does not determine to store the background template image, the background template image is not stored. For example, after the user selects the background template as a text or a thumbnail image, the user may not store the background template image if the user is not satisfied, unlike the case where the actually-received background template image is determined as the thumbnail image or explanation text. In an exemplary embodiment in which all images of background templates described in the background template list are stored in a memory, only a process of selecting a background template (S620) is needed while operations S630 through S660 are not necessary.

In operations S670, it is determined whether the background template uploading process is ended. The background template uploading process may be ended by a user's specific instruction or when a predetermined amount of time has elapsed without a user's specific instruction. If the user selects another background template from the background template list in operation S620, the background template uploading process is not ended and the above-described operations S620 through S660 are repeatedly performed.

If it is determined that the background template uploading process is ended, the digital photographing apparatus stores or updates the background template list in operation S680. When the background template list is first received, the background template list is stored. However, when the background template list has been previously stored and another background template list is received, the background template list that has been previously stored is updated. The background template list is updated by replacing an existing background template list with the received background template list or by adding the received background template list to the existing background template list.

FIG. 7 is a flowchart illustrating a process of printing a synthesized image according to an exemplary embodiment of the present invention.

In operation S710, the user searches a background template list. In operation S720, the user determines whether a desired background template to be combined with a photographic image as a background template list exists. If the desired background template does not exist, the desired background template is uploaded through a background template uploading process (S740) so that the user can select the desired background template.

If the user selects the desired background template as the background template list, in operation S730, it is determined whether an image of the selected background template exists in the memory. If the image of the selected background template does not exist, the background template image is requested from an external network or apparatus in which the selected background template is stored and the background template image is received in operation S750.

If an image of the desired background template is prepared, the background template image and the photographic image are combined with each other so that a synthesized image is composed in operation S760. A more detailed operation of composing the synthesized image will be described with reference to FIG. 8.

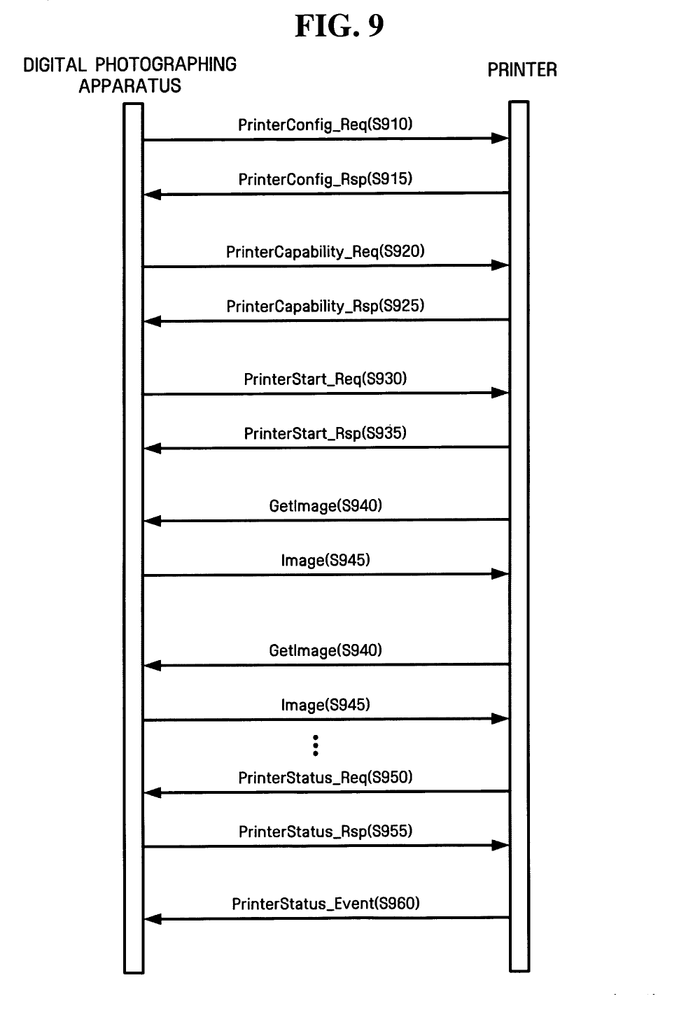

The synthesized image is printed to the printer through an image printing process in operation S770. A more detailed operation thereof will be described with reference to FIG. 9.

The background template list is used in the exemplary embodiments in FIGS. 6 and 7. In another exemplary embodiment of the present invention, the background template list may not be used. In this exemplary embodiment, receiving, storing, and updating the background template list is unnecessary, and a process of searching a background template list is changed into a process of searching a background template.

FIG. 8 is a flowchart illustrating a process of composing a synthesized image according to an exemplary embodiment of the present invention.

A photographic image self may be included in the synthesized image or only a part of the photographic image may be included in the synthesized image. The case where only a part of the photographic image is included in the synthesized image will now be described.

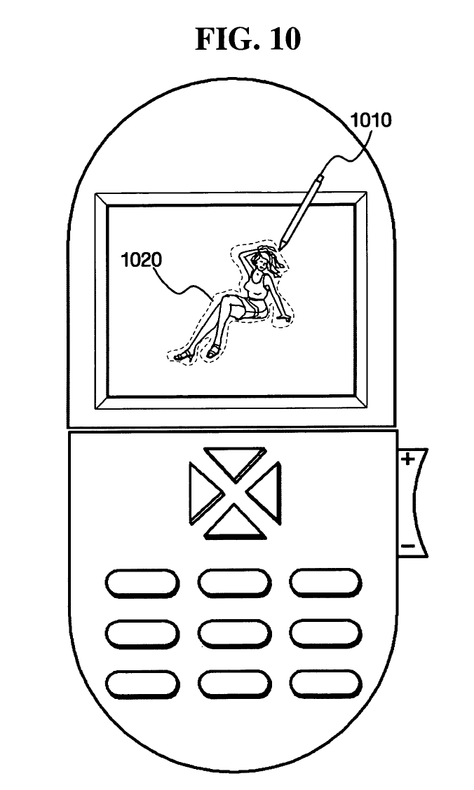

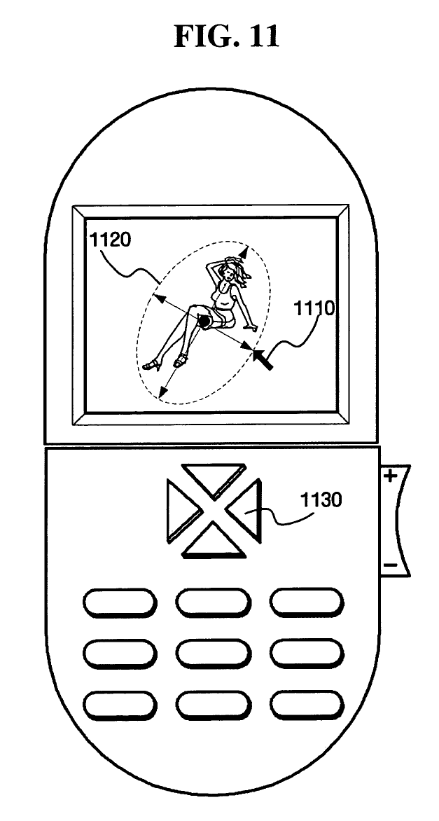

In operation S810, a process of determining a mode for selecting a region of a (photographic) image is performed. When the user selects a manual image region selection mode, the user selects an image region to be included in the synthesized image through a user interface in operation S820. Selecting the manual image region will be described later with reference to FIGS. 10 and 11. When the user selects an automatic image region selection mode, the microprocessor selects an image region automatically in operation S825. To this end, the microprocessor selects a partial region of an image according to a predetermined programmed algorithm. For example, the microprocessor may select an image region by roughly calculating contours of a human body using image processing or select a portion excluding a right and left predetermined region of an image. In a latter case, a property in which a person is usually placed in the center in a figure photograph is used.

If the image region is selected, a process of composing a synthesized image is performed. The user selects a synthesized image composition mode in operation S830. After the user selects a manual synthesized image composition mode, the user combines the photographic image with a background image through the user interface in operation S840. When the user selects automatic synthesized image composition, an automatic image synthesis composition process is performed in operation S845. For example, the microprocessor makes the central portion of the photographic image and the central portion of the background template image coincide with each other and shows only a photographic image from an overlapped portion of the two images, thereby composing a synthesized image, or combines the background template image and the photographic image to be overlapped with each other. In addition, when the background template image is a background effect, the microprocessor may show the background template image first when the photographic image and the background template image are overlapped with each other, or combine the background template image and the photographic image to be overlapped with each other.

FIG. 9 is a flowchart illustrating a direct image printing process according to an exemplary embodiment of the present invention.

In operation S910, a digital photographing apparatus notifies start of an image printing process using a message PrinterConfig_Req. A parameter for PrinterConfig_Req may include information on the name, identifier or manufacturer of the digital photographing apparatus. In operation S915, a printer which receives the message PrinterConfig_Req transfers a message PrinterConfig_Rsp, which is a response message for PrinterConfig_Req, to the digital photographing apparatus. A parameter for PrinterConfig_Rsp may include information on the name, identifier or manufacturer of a printer.

In operation S920, the digital photographing apparatus receives the message PrinterConfig_Rsp, transfers a message PrinterCapability_Req to the printer, and requests values that can be supported by the printer. In operation S925, the printer which receives the message PrinterCapability_Req transfers the message PrinterCapability_Rsp to the digital photographing apparatus. A parameter for PrinterCapability_Rsp may include functions supported by the printer, for example, values related to fonts, paper size, paper type, and layout.

In operation S930, the digital photographing apparatus which receives the message PrinterCapability_Rsp transfers a message PrinterStart_Req to the printer. A parameter for PrinterStart_Req may include an identifier for a photographic image, an identifier for a background template, and combination information of a photographic image and a background template. In operation S935, the printer which receives the message PrinterStart_Req responds to the digital photographing apparatus using the message PrinterStart_Rsp.

In operation S940, the printer requests transfer of actual image data to the digital photographing apparatus using a message GetImage. A parameter for the message GetImage includes an image identifier to be transferred. In operation S945, the digital photographing apparatus which receives the message GetImage transfers a corresponding image to the printer. This image transfer process may be repeatedly performed several times according to the number of images.

A (photographic) image transferred to the printer is an image actually captured by the digital photographing apparatus (or an image captured by another digital photographing apparatus and stored) and a background template image.

In an exemplary embodiment of the present invention, an image transferred to the printer is a synthesized image in which an image actually captured by a digital photographing apparatus and a background template image are combined with each other.

In another exemplary embodiment of the present invention, an image transferred to the printer is an image captured by a digital photographing apparatus. In this exemplary embodiment, the printer selects a background template stored in the printer using a background template identifier and combines the selected background template and the image received from the digital photographing apparatus with each other using combination information thereof, thereby composing a synthesized image.

If image transfer is completed, the digital photographing apparatus requests for the status of the printer using a message PrinterStatus_Req in operation S950. The printer that has received the message PrinterStatus_Req transfers a message PrinterStatus_Rsp to the digital photographing apparatus in operation S955. A parameter of the message PrinterStatus_Rsp may include information on images received by the printer and information on the composed synthesized image. In operation S960, the printer notifies the digital photographing apparatus that the synthesized image is printed to the printer, using a message PrinterStatus_Event. In operation S970, the printer composes the synthesized image and performs a printing process.

FIG. 10 illustrates a process of manually selecting an image region according to an exemplary embodiment of the present invention.

Referring to FIG. 10, a manual image is selected using a touch pen 1010. While drawing a figure photograph region from a photograph displayed by the digital photographing apparatus using the touch pen 1010, a region 1020 marked by a dotted line is selected.

FIG. 11 illustrates a process of manually selecting an image region according to another exemplary embodiment of the present invention.

When such a touch pen as shown in FIG. 10 is not available, an image region may be selected using a keypad 1130. For example, a user may move an arrow 1110 using the keypad 1130 to select the center of a desired region. In addition, the user can select a region 1120 marked by a dotted line by drawing a predetermined geometrical figure, for example, a circle or an ellipsoid, on the basis of the center of the desired region.

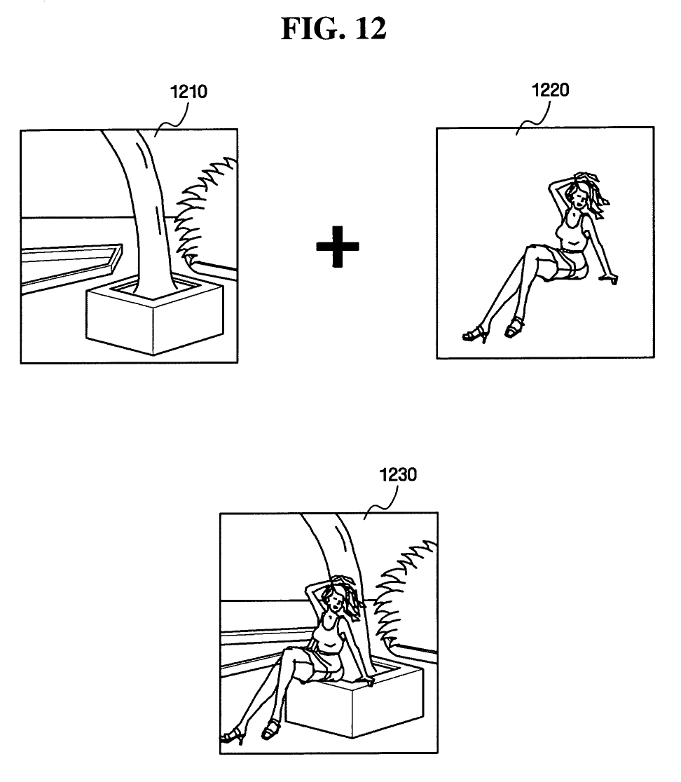

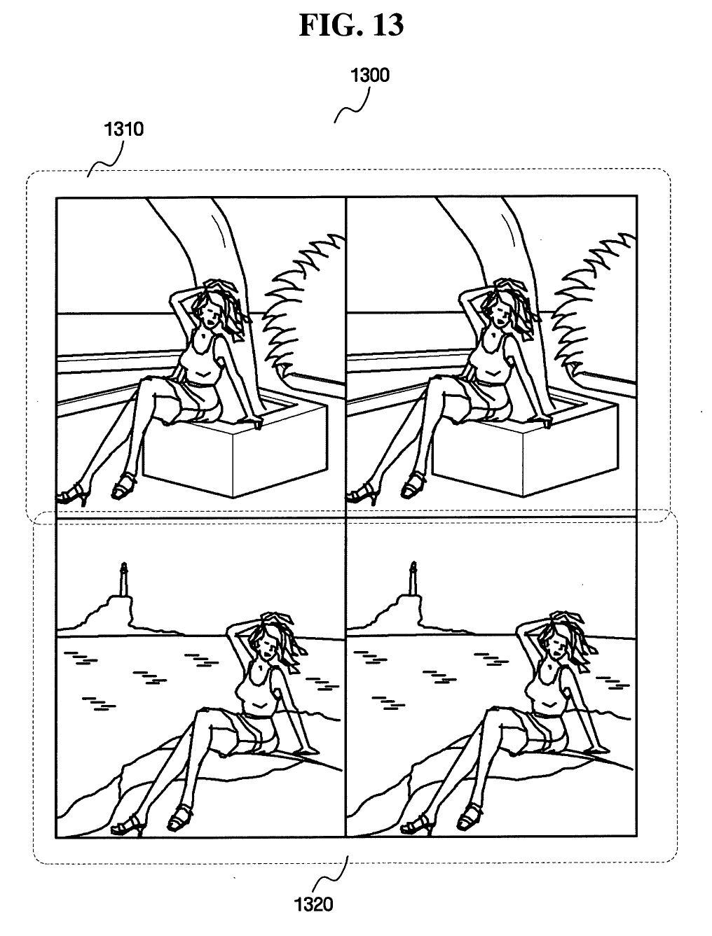

FIG. 12 illustrates a synthesized image composed according to an exemplary embodiment of the present invention.

A background template image 1210 is combined with an image 1220 captured by a digital photographing apparatus and becomes a synthesized image 1230. In an exemplary embodiment of the present invention, as shown in FIG. 12, a part of a background template selected from the synthesized image 1230 is hidden. In another exemplary embodiment of the present invention, a background template and an image may be overlapped with each other in the synthesized image 1230. As shown in FIG. 12, the background template image may be a predetermined background image, e.g., a garden, seaside or forest background image, or a background effect, e.g., a rainy, snowy or twinkling appearance.

FIG. 13 illustrates a synthesized image composed according to another exemplary embodiment of the present invention.

A synthesized image 1300 shown in FIG. 13 may be composed by combining a plurality of background template images 1310 and 1320 with one image, unlike the synthesized image 1230 shown in FIG. 12.

As described above, in the method and apparatus for directly printing a synthesized image combined with a background template according to exemplary embodiments of the present invention, a digital photographing apparatus can directly print a synthesized image to a printer. Thus, a user can combine a photographic image with a background template using a printer and print it to the printer without having to connect the digital photographing apparatus to a computer.

In addition, since the synthesized image can be printed to the printer without directly transferring the background template in a printing process, the amount of data to be transferred can be reduced for printing.

Those skilled in the art will appreciate that many variations and modifications can be made to the exemplary embodiments without substantially departing from the principles of the present invention. For example, the printer may be a stand-alone printer or a commercial sticker output apparatus incorporating a billing device. Therefore, the disclosed exemplary embodiments of the invention are used in a generic and descriptive sense only and not for purposes of limitation. The scope of the invention is given by the appended claims, rather than the preceding description, and all variations and equivalents which fall within the range of the claims are intended to be embraced therein.

1. A method for directly printing a synthesized image, comprising:
selecting a background template image to be combined with a photographic image;
combining the selected background template image with the photographic image and composing a synthesized image; and
transferring the photographic image and a combination information of the background template image and the photographic image to a printer.

2. The method of claim 1, wherein the selecting a background template image comprises:
searching a first background template list including information in which background template images are simplified; and
selecting a desired background template image.

3. The method of claim 2, wherein the background template list includes thumbnail images for background template images.

4. The method of claim 2, wherein the selecting of a background template image further comprises receiving the background template image from an external network when the background template image searched from the first background template list is not stored in a memory.

5. The method of claim 2, wherein the selecting a background template image further comprises receiving a second background template list and the background template image from an external network or apparatus when the desired background template is not included in the first background template list, and updating the first background template list.

6. The method of claim 1, wherein the combination information includes an identifier for the selected background template image, region information for the photographic image, and combination location information of the selected background template image and the photographic image.

7. A method for directly printing a synthesized image, comprising:
receiving a photographic image and a combination information of a first background template image and the photographic image from a digital photographing apparatus;
combining the first background template image and the received photographic image according to the received combination information and composing a synthesized image; and
printing the synthesized image.

8. The method of claim 7, wherein the first background template image is a background template image stored in a memory.

9. The method of claim 8, further comprising transferring a second background template image stored in the memory to the digital photographing apparatus after receiving a transfer request for the second background template image from the digital photographing apparatus.

10. The method of claim 8, further comprising transferring a background template list to the digital photographing apparatus after receiving a transfer request for the background template list from the digital photographing apparatus, the background template list including simplified information of background template images stored in the memory.

11. The method of claim 10, wherein the background template list includes thumbnail images for background template images stored in the memory.

12. The method of claim 7, wherein the combination information includes an identifier for the first background template image, region information for the photographic image, and combination location information of the first background template image and the photographic image.

13. A digital photographing apparatus comprising:
a photographing unit converting incident light into an image signal;
a memory in which a photographic image captured by the photographing unit and a background template image are stored;
a user interface to which a user instruction is input;
a display unit which displays the photographic image and the background template image to the user;
a microprocessor combining the photographic image and the background template image according to the user instruction input through an instruction inputting unit and composing a synthesized image; and
a communication unit transferring the photographic image and combination information of the background template image and the photographic image to a printer.

14. The digital photographing apparatus of claim 13, wherein a background template list including simplified information of background template images is further stored in the memory.

15. The digital photographing apparatus of claim 14, wherein the background template list includes thumbnail images for background template images.

16. The digital photographing apparatus of claim 13, wherein the memory includes a flash memory.

17. The digital photographing apparatus of claim 13, wherein the user interface includes a keypad.

18. The digital photographing apparatus of claim 13, wherein the display includes a liquid crystal display.

19. The digital photographing apparatus of claim 13, wherein the combination information transferred to the printer includes an identifier for a background template image, and combination information of a photographic image and the background template image.

20. A printer comprising:
a communication unit receiving an image and a combination information of a background template image and the image from a digital photographing apparatus;
a memory in which a background template image is stored;
a microprocessor combining the background template image stored in the memory and the received image according to the received combination information and composing a synthesized image; and
a printing unit printing the synthesized image.

21. The printer of claim 20, wherein a background template list including simplified information of background template images is further stored in the memory.

22. The printer of claim 20, wherein the background template list includes thumbnail images for background template images.

23. A recording medium having a computer readable program recorded therein, the program executing the method of claim 1.

24. A recording medium having a computer readable program recorded therein, the program executing the method of claim 7.
